(19) United States
(12) Patent Application Publication
(10) Pub. No.: US 2006/0226052 A1
(43) Pub. Date: Oct. 12, 2006

(54) Frame member in a circular screen vibrator

(75) Inventor: Si-Lin Yu, Taipei City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: LAO SOUNG Machinery Co., Ltd.

(21) Appl. No.: 11/399,356

(22) Filed: Apr. 7, 2006

(30) Foreign Application Priority Data
Apr. 12, 2005 (TW) 094111569

(51) Int. Cl. B07B 1/54

(52) U.S. Cl. 209/382

(57) ABSTRACT

A frame member of a circular vibration screener provides an annular vertical frame wall, a joining rim, being provided at two lateral ends of the frame wall respectively and at least a reinforced flange, protruding from the periphery of the frame wall such that the frame member is able to increase strength and rigidity against deformation and for prolonging the life span thereof.

### FIELD OF THE INVENTION

The present invention relates to a circular frame member structure, and, particularly to a reinforced frame member structure in a circular screen vibrator, in which an inward or outward reinforced flange is provided at the lower half part and/or upper half part of the frame member to increase strength and rigidity against deformation for prolonging life span.

### BACKGROUND OF THE INVENTION

The screen vibrator usually used for screening powder or filter screened substances. The worked raw material or stuff is fed into the screen vibrator from the inlet at the top thereof and treated with vibration and different screen holes such that the raw material or stuff is classified in different grades based on sizes of particles thereof for being separated easily in use and removing impurities. Hence, the screen vibrator is widely applied in the fields of plastics industry, food industry or medicine industry. Due to material science rapidly progressing recently, the electronic industry, which is belonged to high technology, uses the screen vibrator for screening raw material they need.

Generally, the screen vibrator provides a vibration base with a vibration motor at the lower part thereof and at least two set of frame members being disposed on the base with a screen holder being sandwiched by the frame members to perform screening separation via different screen holes. Mostly, improvement on the screen vibrator is focused on the vibration body, material out control device, material in device and screen holder but improvement for the frame member is seldom mentioned. Taiwanese Patent Publication No. 192744 entitled “FRAME MEMBER OF A SCREEN VIBRATOR” discloses a plurality of slant frame plates at the inner wall surface of the frame member to guide moving direction of the raw material or stuff. But, alternatives for resisting the frame member from deformation are not proposed in the prior art.

In fact, the frame member used in the screen vibrator is made of sheet metal and the sheet metal is cut and rolled as an annular shape with both ends thereof being welded as a joint. However, the sheet metal is easily deformed in case of being carelessly operated and it is unfavorable for the frame member joining with the screen holder and affects quality of grade separation. Therefore, how to increase strength and rigidity of the frame member against deformation for prolonging life span is a difficult problem needs to be solved.

### SUMMARY OF THE INVENTION

An object of the present invention is to provide a frame member in a circular screen vibrator, which provides an annular upright frame wall with an extending outward connecting rim at the upper and lower ends thereof and the circumferential side of the frame member protrudes at least a reinforced flange.

Another object of the present invention is to provide a frame member in a circular screen vibrator, in which the reinforced flange is disposed at the upper half part and/or lower half part protruding inward or outward from the frame wall.

A further object of the present invention is to provide a frame member in a circular screen vibrator, in which a laid edge is formed at the intersection of the reinforced flange and the frame wall.

### BRIEF DESCRIPTION OF THE DRAWINGS

The present invention can be more fully understood by reference to the following description and accompanying drawings, in which:

FIG. 1 is a perspective view of the frame member of a circular screen vibrator screen according to the present invention;

FIGS. 2 is a sectional view of FIG. 1;

FIG. 3 is a sectional view of the second embodiment of the frame member in a circular screen vibrator according to the present invention;

FIG. 4 is a sectional view of the third embodiment of the frame member in a circular screen vibrator according to the present invention; and

FIG. 5 is a sectional view of the fourth embodiment of the frame member in a circular screen vibrator according to the present invention.

### DETAILED DESCRIPTION OF THE INVENTION

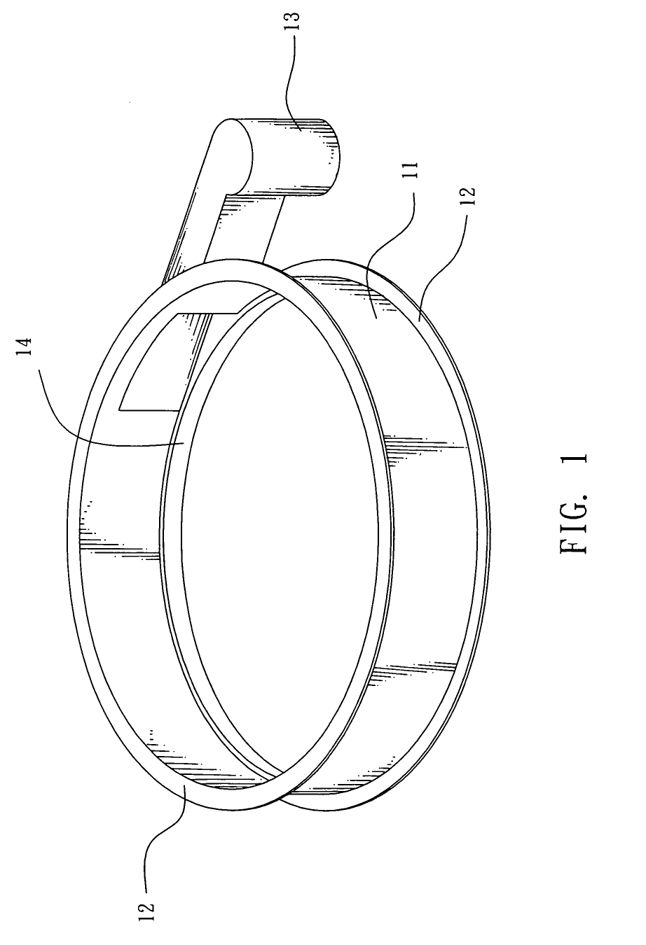

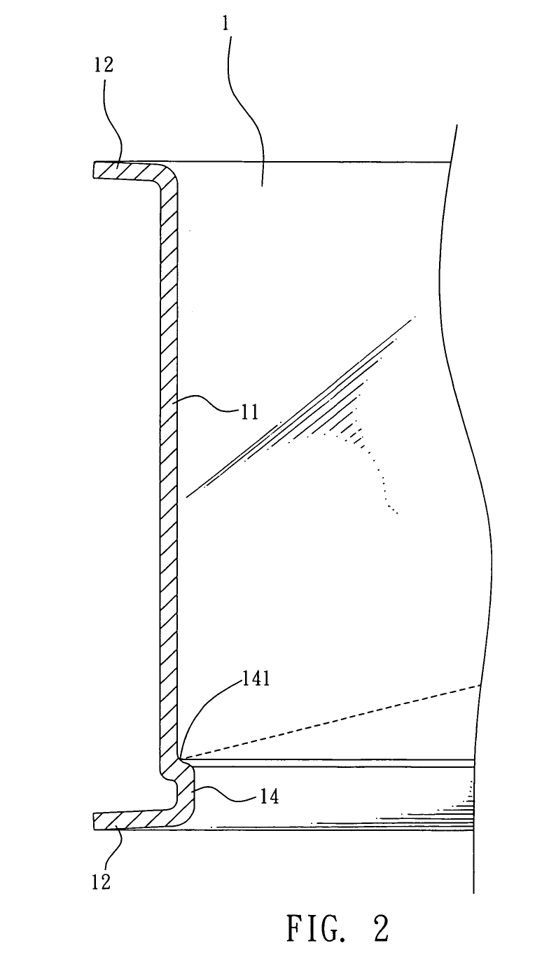

Referring to FIGS. 1 and 2, basically, the frame member 1 in a circular screen vibrator according to the present invention provides the same configuration as the conventional one, that is, the frame member 1 has annular shaped vertical frame wall 11 and the upper and lower sides thereof extend outward a joining rim 12 respectively such that a screen holder is sandwiched by the frame member 1 and another frame member 1 underneath and a retainer is used for locating the two adjacent joining rims and the screen holder. Besides, the frame wall 11 has an outlet 13 for the screened material or the impurity being discharged. It is noted that the preceding is prior art and no detail will be described further.

The special feature of the present invention is in that the frame wall 11 at least provides a reinforced flange 14 at the upper half part and/or the lower half part protruding inward or outward to increase rigidity and strength of the frame member 1. Hence, it is capable of resisting the frame member 1 from being deformed and maintaining true roundness thereof such that other frame members and screen holders being able to couple with it. It can be seen in FIGS. 1 and 2 that the reinforced flange 14 is disposed at the lower half part and it is preferable that the reinforced flange 14 protrudes inward for forming a laid edge 141 between the frame wall 11 and the flange 14. The laid edge 141 has advantages described hereinafter. (a) The laid edge 141 can be laid by a conical plate material shown with dash line in FIG. 2 and the conical plate can be joined to the frame member 1 by way of welding fast without need of an inconvenient working process of using a locating fixture to hold plate material; (b) The laid edge 141 can be relied with measurement tool such as ruler for assisting work in addition to sketching line conveniently instead of a circular arc end at intersection of the frame wall 11 and the joining rim 12 being used as a reference position to result in possible measurement error.

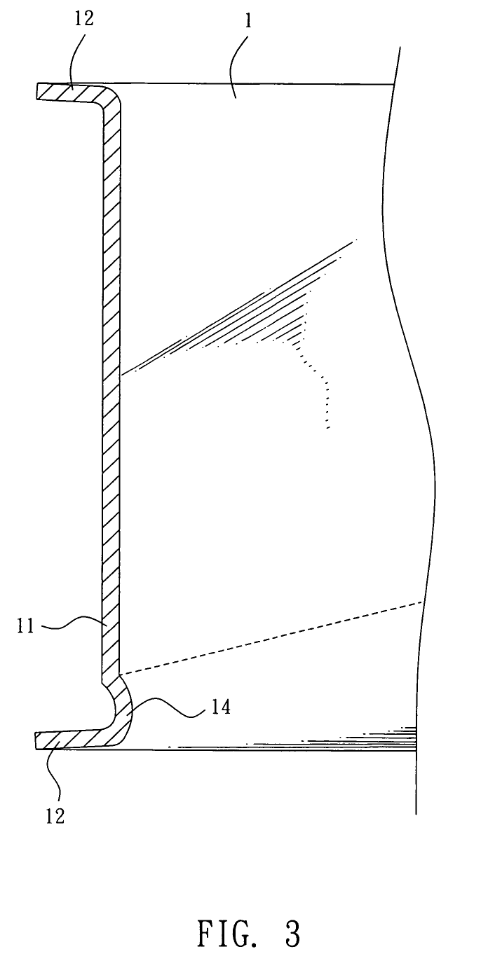

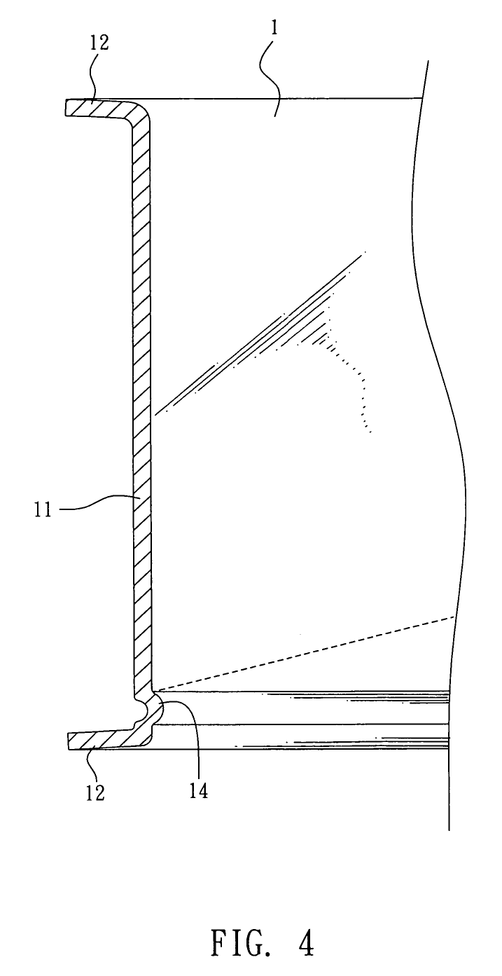

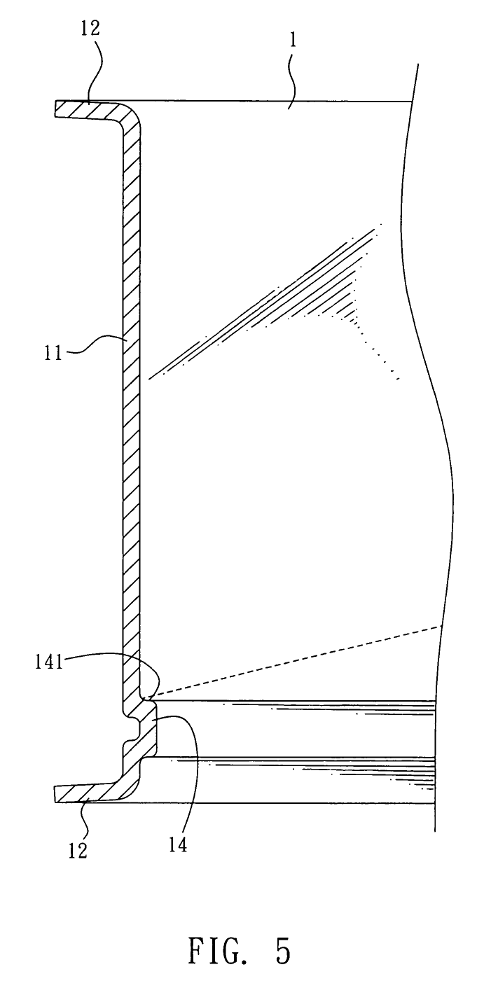

Referring to FIG. 2, the reinforced flange 14 is at the intersection of the frame wall 11 and the joining rim 12 with a straight protrusion. FIGS. 3 to 5 show the second to the fifth embodiment of the reinforced flange 14. FIG. 3 shows the reinforced flange 14 is at the conjunction of the frame wall 11 and the joining rim 12 with a circular protrusion. FIG. 4 shows the reinforced flange 14 is disposed at the lower half part of the frame wall 11 with a circular protrusion. FIG. 5 shows the reinforced flange 14 is disposed at the lower half part of the frame wall 11 with a straight protrusion. Hence, the reinforced flange 14 is capable of increasing strength and rigidity of the frame member effectively against deformation, being joined to the plate material fast and acting as a reference line during measuring.

It is appreciated that the frame member in a circular screen vibrator according to the present invention provides at least an inward or outward reinforced flange at the upper half part and/or the lower half part thereof so as to increase strength and rigidity of the integral frame member such that the frame member is able to resist deformation and maintain the true roundness thereof for obtaining longer life span. Furthermore, at least an inward reinforced flange, which is disposed at the lower half part of the frame member, is capable of being joined to the plate material speedily and being used as a reference line for measurement in addition to strengthening the frame member.

While the invention has been described with reference to the preferred embodiments thereof, it is to be understood that modifications or variations may be easily made without departing from the spirit of this invention, which is defined by the appended claims.

What is claimed is:

1. A frame member in a circular screen vibrator, comprising:
an annular vertical frame wall;
a joining rim, being provided at two lateral ends of the frame wall respectively; and
at least a reinforced flange, extending from the periphery of the frame wall.

2. The frame member in a circular screen vibrator as defined in claim 1 wherein the reinforced flange is disposed at the upper half part and/or the lower half part of the frame wall.

3. The frame member in a circular screen vibrator as defined in claim 1, wherein the reinforced flange inward or outward protrudes from the frame wall.

4. The frame member in a circular screen vibrator as defined in claim 1, wherein a laid edge is formed at the intersection of the reinforced flange and the frame wall.

5. The frame member in a circular screen vibrator as defined in claim 1, wherein the reinforced flange is formed at the intersection of the reinforced flange and the frame wall with a straight protrusion.

6. The frame member in a circular screen vibrator as defined in claim 1, wherein the reinforced flange is formed at the intersection of the reinforced flange and the frame wall with a circular protrusion.

7. The frame member in a circular screen vibrator as defined in claim 1, wherein the reinforced flange is formed at the lower half part of the frame wall a circular protrusion.

8. The frame member in a circular screen vibrator screener as defined in claim 1, wherein the reinforced flange is formed at the lower half part of the frame wall a straight protrusion.
